(19) United States
(12) Patent Application Publication
(10) Pub. No.: US 2013/0313455 A1
(43) Pub. Date: Nov. 28, 2013

(54) ELECTRICAL RECIRCULATION AIR VALVE

(71) Applicant: EAGLE ACTUATOR COMPONENTS GMBH & CO. KG, Weinheim (DE)

(72) Inventor: Joerg BITTNER, Laudenbach (DE)

(73) Assignee: EAGLE ACTUATOR COMPONENTS GMBH & CO. KG, Weinheim (DE)

(21) Appl. No.: 13/864,540

(22) Filed: Apr. 17, 2013

(30) Foreign Application Priority Data
May 24, 2012 (DE) 10 2012 010 140.6

(51) Int. Cl. F16K 31/06

(52) U.S. Cl. CPC F16K 31/0658
USPC 251/129.15

(57) ABSTRACT

A valve for use in a turbocharger of a motor vehicle, comprising a housing, a movable valve body and an electromagnetic actuating device, whereby a sealing device is arranged on one end of the movable valve body in order to rest in a sealing manner on a sealing seat, whereby the electromagnetic actuation device moves the valve body and whereby a radial sealing area is provided on the sealing device which area can be placed on an inner wall of the housing, as regards the task of realizing a valve whose sealing device can readily seal an opening with a relatively large diameter, given a suitable construction, characterized in that the radial sealing area and the sealing device are constructed in one piece and from the same material.

### CROSS REFERENCE TO RELATED APPLICATIONS

This application claims priority to German Patent Application No. 10 2012 010 140.6 filed on May 24, 2012, the disclosure of which is incorporated by reference herein in its entirety.

### FIELD OF THE INVENTION

The invention relates to a valve for use in a turbocharger of a motor vehicle, comprising a housing, a movable valve body and an electromagnetic actuating device, whereby a sealing device is arranged on one end of the movable valve body in order to rest in a sealing manner on a sealing seat, whereby the electromagnetic actuation device moves the valve body and whereby a radial sealing area is provided on the sealing device which area can be placed on an inner wall of the housing, characterized in that the radial sealing area and the sealing device are constructed in one piece and with the same material.

### BACKGROUND

The valves of the prior art comprise sealing devices which are associated with radial sealing rings that can be moved in common with the sealing device.

Such a radial sealing ring is elastically constructed in such a manner that it can reliably bring about a smooth sliding on an inner wall, almost independently of the geometry of this inner wall, without all too great contact pressures.

The known valves have the disadvantage that the radial sealing ring is manufactured separately and must be adapted to the dimensions of the sealing device. It is also disadvantageous that the radial sealing ring can come loose from the sealing device during operation.

### SUMMARY

The invention therefore has the basic task of realizing a valve whose sealing device can readily seal an opening with a relatively large diameter given a construction suitable for the operation.

A valve in accordance with the invention for being used in a turbocharger of a motor vehicle comprises a housing, a movable valve body and an electromagnetic actuating device, whereby a sealing device is arranged on one end of the movable valve body in order to rest in a sealing manner on a sealing seat, whereby the electromagnetic actuation device moves the valve body and whereby a radial sealing area is provided on the sealing device which area can be placed on an inner wall of the housing.

The invention provides that the radial sealing area and the sealing device are constructed in one piece and from the same material.

It was recognized by the invention that this can save expensive manufacturing steps since no separate structural sealing part has to be arranged on the sealing device. It was furthermore recognized that this can realize a fluid-tight separation of two fluid lines almost independently of the entire circumferential surface of the sealing device. The sealing device can be constructed very narrowly in areas in the radial direction, whereby a good seal is nevertheless made possible.

In particular, the sealing device can comprise a middle part that is greatly constricted opposite the end on which the radial sealing area is constructed and opposite the end facing the sealing seat. The sealing device can project out very far in the radial direction on its end facing the sealing seat, whereby a middle part is constructed to be very narrow and whereby the radial sealing area lies very closely against the inner wall of the housing in a suitable manner. To this extent a valve is realized who's sealing device can readily seal an opening with a relatively large diameter given a construction suitable for the operation.

Consequently, the initially cited task is solved.

The radial sealing area and the sealing device could be manufactured from polytetrafluoroethylene (PTFE). This material can be readily worked, has a good chemical resistance and displays very good sliding properties.

The inner wall of the housing could comprise a first cylindrical section with a first inside diameter that is set off or separated by a step in the axial direction from a second cylindrical section with a larger, second inside diameter. As a result, the contact pressure of the radial sealing area against the inner wall can be considerably reduced very rapidly.

A general reduction of the contact pressure as is taught by the prior art according to EP 1 941 138 B1 is advantageously not realized. Here, the electromagnetic actuation device is not overloaded during a rather long movement path but rather suddenly freed from the overwhelming contact pressure of the radial sealing area.

The radial sealing area could comprise a circumferential sealing lip resting in a sliding manner on the first cylindrical section. This makes possible a reliable sealing of two fluid lines.

A sealing element could be constructed or arranged on the free end of the sealing device, which element projects out like a bell in the radial direction. As a result of the bell-like or goblet-like projection a relatively large opening of a fluid line can be sealed without designing the middle part or other parts of the sealing device to radially project in a similarly far manner.

Given this background, a sealing element could be constructed or arranged on the free end of the sealing device which element comprises a radially projecting contact lip for resting on the sealing seat. The contact lip preferably forms a goblet or a bell shape. The contact lip can preferably be slightly deformed and can therefore compensate irregularities on a contact surface on the sealing seat.

The sealing device could have a constriction between the contact lip and the radial sealing area the outside diameter of which constriction is reduced by 5-9%, preferably 10-19%, more preferably by 20-39% and especially preferably by 40-80% relative to the maximum outside diameter of the contact lip. A reduction of 5-9% brings about a moderate slimming of the sealing device. A reduction of 10-19% brings about a relatively distinct slimming of the sealing device. A reduction of 20-39% brings about a great slimming of the sealing device and a reduction of 40-80% brings about a very great slimming of the sealing device. The degree of the constriction is advantageously selected in such a manner that in the case of a structurally conditioned compactness of the sealing device flow passages can be provided in it that are still suitably wide in order to be able to open the valve rapidly and sufficiently without problems.

Given this background, the sealing element could be provided with flow passages that allow a passage of a fluid for establishing pressure compensation between the side of the sealing element facing the sealing seat and the side of the sealing element facing away from the sealing seat. A pressing of the sealing device on the sealing seat is made possible by the flow passages, which pressure is brought about either exclusively or almost exclusively by a spring force. The fluid pressure on the side of the sealing element facing the sealing seat and the fluid pressure on the side of the sealing element facing away from the sealing seat are advantageously identical or almost identical. Thus, a pressure-compensated or almost completely pressure-compensated valve can be produced.

An adapter element could be provided that is fastened on the valve body, whereby the adapter element carries the sealing device. It is advantageous here that the sealing device can be manufactured from a relatively flexible material. The main load in use can thus be carried by the adapter element, whereby the sealing device can only meet sealing purposes.

The inner wall of the housing could be constructed in one piece and with the same material as an injection-molded jacket of the housing. As a result, a construction with few parts can be realized. No other housing part that has to be clipped onto an existing housing is necessary.

The inner wall of the housing could be constructed as a replacement part that can be arranged between a machine block and the electromagnetic actuation device. A replacement part allows different electromagnetic actuation devices to be combined with different sealing devices. A sealing device can be mounted on a valve body that is a component of an electromagnetic actuation device. The inner housing wall can subsequently be selected in such a manner that the entire valve can be set on a machine block.

Given this background, an arrangement could comprise a machine block and a valve of the type described here, whereby a first fluid line and a second fluid line are constructed in the machine block that can be separated from one another by the valve and connected to one another in a fluid-conducting manner. The machine block can advantageously be part of a turbocharger of a motor vehicle. However, it is also conceivable that the machine block is part of another unit comprising two fluid lines that are to be separated from one another.

The first fluid line could be surrounded by a sealing seat onto which the sealing device can be placed in a sealing manner. To this end the sealing seat preferably comprises a contact surface.

The sealing device could rest in the currentless state of the electromagnetic actuation device on the sealing seat and be loaded by a spring force. A spring can ensure a sealing contact in a reliable manner and independently of the pressures in the fluid lines.

### BRIEF DESCRIPTION OF THE DRAWING

FIG. 1 shows a sectional view of an arrangement of a valve in a motor vehicle;

FIG. 2 shows the rectangular section Z according to FIG. 1 in dotted lines and an enlarged view;

FIG. 3 is a view of a concrete dimensioning of a sealing device and of a sealing element; and

FIG. 4 shows a sectional view of an arrangement of another valve in a motor vehicle, whereby an adapter element is fastened on the valve body and carries the sealing device, which adapter element is clipped to the sealing device.

### DETAILED DESCRIPTION

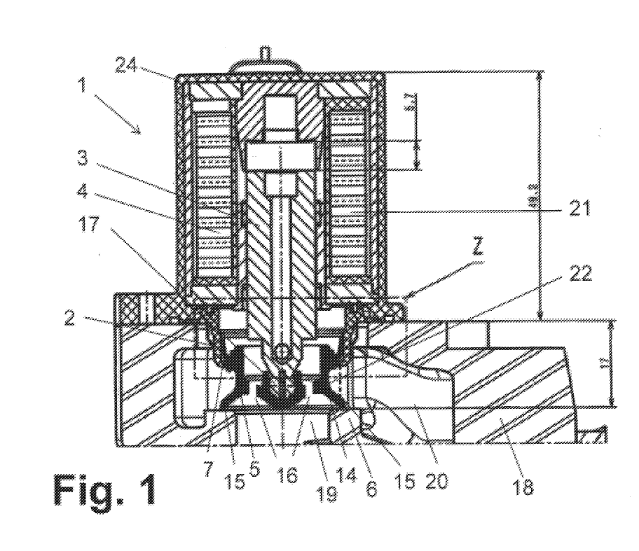

FIG. 1 shows a valve 1 for use in a turbocharger of a motor vehicle, comprising a housing 2, a movable valve body 3 and an electromagnetic actuation device 4, whereby a sealing device 5 is arranged on one end of the movable valve body 3 in order to sit in a sealing manner on a sealing seat 6, whereby the electromagnetic actuation device 4 moves the valve body 3 and whereby a radial sealing area 7 is provided on the sealing device 5, which area 7 can be placed on an inner wall 9 of the housing 2 or rests on it.

The radial sealing area 7 and the sealing device 5 are manufactured in one piece and with the same material. The radial sealing area 7 is formed out of the sealing device 5. The radial sealing area 7 and the sealing device 5 are manufactured from polytetrafluoroethylene (PTFE).

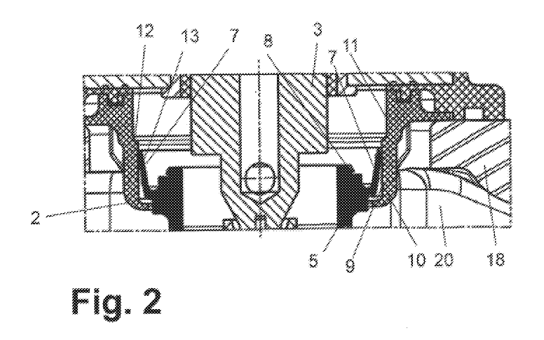

FIG. 2 shows that the inner wall 9 of the housing 2 has a first cylindrical section 10 with a first inside diameter that is set off or separated by a step 12 in the axial direction from a second cylindrical section 11 with a larger, second inside diameter.

The radial sealing area 7 has a circumferential sealing lip 13 that rests in a sliding manner on the first cylindrical section 10. The sealing lip 13 is manufactured from PTFE.

FIG. 1 shows that a sealing element 14 is formed or arranged on the free end of the sealing device 5, which element projects out like a bell in the radial direction. The sealing element 14 is formed out of the sealing device 5 and is formed with the same material and in one piece with the latter. It is also manufactured from PTFE.

A sealing element 14 is formed or arranged on the free end of the sealing device 5 which element comprises a radially projecting contact lip 15 for resting on the sealing seat 6.

The sealing element 14 is provided with flow passages 16 that allow a passage of a fluid for establishing a pressure compensation between the side of the sealing element 14 facing the sealing seat 6 and the side of the sealing element 14 facing away from the sealing seat 6.

The sealing element 14 is formed in one piece and integrally with the sealing device 5. The sealing device 5 is fastened positively on a spherical head 17 of the valve body 3, preferably engaged with or clipped to the spherical head 17.

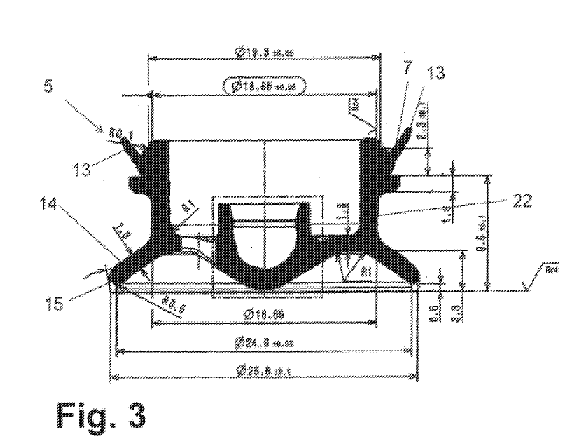

FIG. 3 shows a concrete dimensioning of a sealing device 5, whereby the diameters (φ) are indicated in mm. FIG. 3 concretely shows that the contact lip 15 exhibits an outside diameter of 25.6 mm at its widest point, whereby the sealing ring 5 exhibits an outside diameter of 18.65 mm at its narrowest point, here the constriction 22. To this extent the sealing device 5 has a constriction 15 above the contact lip 15 projecting out like a bell, that has an outside diameter that is 72% of the value of the outside diameter of the contact lip 15 at its widest point. Consequently, the sealing device 5 has a constriction 22 between the contact lip 15 and the radial sealing area 7 whose outside diameter is reduced by 20-39% in comparison to the maximal outside diameter of the contact lip 15.

FIG. 1 shows an arrangement comprising a machine block 18 and a valve 1 of the previously described type, whereby a first fluid line 19 and a second fluid line 20 are formed in the machine block 18 which lines can be separated from one another by the valve 1, namely, by the sealing device 5, and which can be connected to one another in a fluid-conducting manner. The first fluid line 19 is surrounded by a sealing seat 6 on which the sealing device 5 can be placed in a sealing manner. The contact lip 15 rests here on a support surface of the sealing seat 6.

The sealing device 5 lies in the currentless state of the electromagnetic actuation device 4 on the sealing seat 6 and is loaded by spring force. The electromagnetic actuation device 4 comprises a coil 21 that produces a force that moves a core, namely, the valve body 3, counter to a spring force away from the sealing seat 6 in the axial direction. As soon as the sealing device 5 lifts off from sealing seat 6 the first fluid line 19 and the second fluid line 20 are connected to one another in a fluid-conducting manner.

The inner wall 9 of the housing 2 is constructed as a replacement part that can be arranged between the machine block 18 and the electromagnetic actuation device 4. This is shown in FIG. 2.

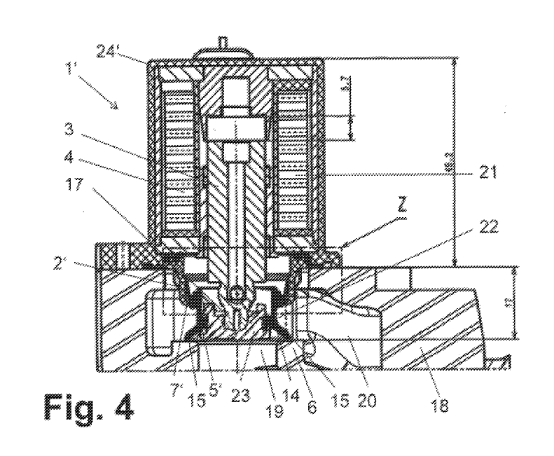

FIG. 4 shows another valve 1′ for use in a turbocharger of a motor vehicle, comprising a housing 2, a movable valve body 3 and an electromagnetic actuation device 4, whereby a sealing device 5′ is arranged on one end of the movable valve body 3 in order to sit in a sealing manner on a sealing seat 6, whereby the electromagnetic actuation device 4 moves the valve body 3 and whereby a radial sealing area 7′ is provided on the sealing device 5′ which area can be placed on or rests on an inner wall 9′ of the housing 2′.

The radial sealing area 7′ and the sealing device 5′ are constructed in one piece and with the same material. The radial sealing area 7′ is built out from the sealing device 5′.

An adapter element 23 is provided that is fastened on the valve body 3, whereby the adapter element 23 carries the sealing device 5′.

The inner wall 9′ of the housing 2′ is constructed with the same material and in one piece with an injection-molded jacket 24 of the housing 2.

What is claimed is:

1. A valve for use in a turbocharger of a motor vehicle, comprising a housing, a movable valve body and an electromagnetic actuating device, whereby a sealing device is arranged on one end of the movable valve body in order to rest in a sealing manner on a sealing seat, whereby the electromagnetic actuation device moves the valve body and whereby a radial sealing area is provided on the sealing device which area can be placed on an inner wall of the housing, wherein the radial sealing area and the sealing device are constructed in one piece and with the same material.

2. The valve according to claim 1, wherein the radial sealing area and the sealing device are manufactured from polytetrafluoroethylene.

3. The valve according to claim 1, wherein the inner wall of the housing comprises a first cylindrical section with a first inside diameter that is set off or separated by a step in the axial direction from a second cylindrical section with a larger, second inside diameter.

4. The valve according to claim 3, wherein the radial sealing area comprises a circumferential sealing lip resting in a sliding manner on the first cylindrical section.

5. The valve according to claim 1, wherein a sealing element is constructed or arranged on the free end of the sealing device, which element projects out like a bell in a radial direction.

6. The valve according to claim 1, wherein a sealing element is constructed or arranged on the free end of the sealing device which element comprises a radially projecting contact lip for resting on the sealing seat.

7. The valve according to claim 6, wherein the sealing device has a constriction between the contact lip and the radial sealing area the outside diameter of which constriction is reduced by 5-9%, preferably 10-19%, more preferably by 20-39% and especially preferably by 40-80% relative to the maximum outside diameter of the contact lip.

8. The valve according to claim 1, wherein the sealing element is provided with flow passages that allow a passage of a fluid for establishing a pressure compensation between the side of the sealing element facing the sealing seat and the side of the sealing element facing away from the sealing seat.

9. The valve according to claim 1, wherein an adapter element is provided that is fastened on the valve body, whereby the adapter element carries the sealing device.

10. The valve according to claim 1, wherein the inner wall of the housing is constructed in one piece and with the same material as an injection-molded jacket of the housing.

11. The valve according to claim 1, wherein the inner wall of the housing is constructed as a replacement part that can be arranged between a machine block and the electromagnetic actuation device.

12. An arrangement comprising a machine block and a valve according to claim 1, in which a first fluid line and a second fluid line are constructed in the machine block that can be separated from one another by the valve and connected to one another in a fluid-conducting manner.

13. The arrangement according to claim 12, wherein the first fluid line is surrounded by a sealing seat onto which the sealing device can be placed in a sealing manner.

14. The arrangement according to claim 12, wherein the sealing device rests in the currentless state of the electromagnetic actuation device on the sealing seat and is loaded by a spring force.
